(19) United States
(12) Patent Application Publication
(10) Pub. No.: US 2004/0132600 A1
(43) Pub. Date: Jul. 8, 2004

(54) Method for manufacturing a packaging laminate

(76) Inventors: Katarina Magnusson, Sodra Sandby (SE); Tom Kjelgard, Lund (SE)

Correspondence Address: JAMES RAY & ASSOCIATES, 2640 PITCAIRN ROAD, MONROEVILLE, PA, 15146, US

(21) Appl. No.: 10/654,372

(22) Filed: Sep. 3, 2003

Related U.S. Application Data
(63) Continuation-in-part of application No. 09/704,651, filed on Nov. 2, 2000, now abandoned.

(51) Int. Cl. B31B 49/00

(52) U.S. Cl. 493/51

(57) ABSTRACT

A method for manufacturing a dimensionally stable and impermeable packaging container from a laminate comprising at least a thermoformable base layer devoid of liquid or moisture soaking properties, a barrier layer and, adjacent to the barrier layer, a laminate layer directed towards the inside of the container. The layers are partially adhered together in a first step to form a laminate. The container is given its desired shape by folding the laminate. Subsequently the folded container is heat treated by subjecting it to autoclaving or hot filling in order to increase the adhesion between the layers and to impart mechanical rigidity to the container.

### FIELD OF THE INVENTION

The present invention relates to the manufacture of a dimensionally stable and impermeable packaging container by means of folding the laminate.

The primary requirement for a container intended for foods is that it should be easy to manufacture and handle as well as be designed and constructed in such a way that it provides the best protection possible to the foods which are to be filled and transported in the container. Good product protection implies, among other things, that the container have sufficient mechanical strength and dimensional stability in order to withstand the outer influences to which the container may be exposed during normal handling without the container being deformed or destroyed. Furthermore, the container should have sufficient physical and chemical impermeability to prevent transport of liquid and/or gases through the walls of the container.

### DESCRIPTION OF THE RELATED ART

Several plastic materials have been extensively used as packaging material for foods because of their strength and other factors, such as their different permeabilities for water vapor, oxygen gas, flavoring agents, etc. However, containers manufactured of only one material do not normally have all the desired properties for a specific application. Consequently, containers of the laminate type have been, more or less, tailored to the different layers of the laminate being adapted to the application in question. In this connection “laminate” means a material which is constructed of more than two layers of material joined together, the materials having different properties to obtain a condition which cannot be achieved with one material only.

In order to be able to use the packaging laminate in containers, for example, the light sensitive products of the laminate has to be supplemented with at least one additional layer of a material with barrier properties. In this connection, such a barrier layer means a laminate layer with good barrier properties against light, gases and/or flavoring agents.

Known packaging laminates comprise a base layer of paper or cardboard, which gives the container strength and dimensional stability, and an outer layer of plastic, preferably polyethylene, which gives the container the necessary impermeability properties against liquid. Furthermore, it makes the packaging laminate heat sealable in such a way that thermoplastic layers facing each other can easily be sealed by means of surface fusion with each other during the manufacturing of containers, in order to form mechanically strong and liquid impermeable sealed joints.

However, the prior art package material have several serious drawbacks, which to a large extent, and sometimes, completely depend on the material used as barrier layer; i.e., a material which is completely impermeable to oxygen and which also has other barrier properties valuable for the filled product; e.g., light impermeability. Such a common barrier material is a metal foil, usually a foil of aluminum.

When containers of the type described above are manufactured, the package material is often subjected to stresses which become especially great when the material is folded. This is due to the fact that the folding of a base layer, having a comparatively large thickness, results in that the other layers in the laminate become substantially stretched or to a corresponding extent compressed along the folding line.

When an aluminum foil is folded, the foil can crack when very great tensile stresses are applied. The risk that this will take place during folding is increased because the aluminum foil is applied against the inside of the laminate, which is covered with one or several plastic layers, usually polyethylene, in order to prevent contact between the aluminum foil and the plastic layer on filled foodstuff.

The prior art package materials also have drawbacks caused by the soaking paper or cardboard layers which rapidly lose their mechanical strength properties and make the container flabby and cumbersome when it is exposed to liquid or moisture. Furthermore, the paper or cardboard layer must be made relatively thick, in order to give the container a necessary dimensional rigidity, which contributes to increasing the material load and thus the risk of crack formation in the aluminum foil during the manufacturing of containers.

### BRIEF SUMMARY OF THE INVENTION

The purpose of the present invention is thus to eliminate the above mentioned drawbacks, which arise when prior art packaging laminates are folded. This accomplished by a two step process. The first step requires partially adhering the layers together to form a laminate capable of being folded without imparting undesirable stresses to the laminate layers, particularly the barrier layer. The second step requires subjecting the folded laminated to a heat treating step to increase the adhesion between the layers and to impart mechanical rigidity to the container.

### DETAILED DESCRIPTION OF THE INVENTION

The packaging laminate, according to the invention, comprises at least one thermoformable base layer, and a laminate layer arranged adjacent to the same which laminate layer is directed towards the inside of the contemplated container.

According to the invention, the packaging laminate is not composed of a usual package material of the laminate type of cardboard or paper but of a plastic material. In such a package material with a strengthening base layer of plastic, a filler can be intermixed with the plastic. Such a filler can, for example, consist of finely ground chalk or kaolin. Thus, the base layer can consist of polypropylene, foamed polypropylene, filled polypropylene, polyethylene terephthalate, filled polyethylene terephthalate, amorphous polyethylene terephthalate or filled amorphous polyethylene terephthalate.

The barrier layer can also consist of aluminum, an aluminum oxide coating, a silica coating, ethylene/vinyl alcohol, polyvinyl alcohol, metalized oriented polyethylene terephthalate or metalized oriented polypropylene.

The laminate layer can consist of polypropylene, high density polyethylene, linear low density polyethylene, polyethylene terephthalate, amorphous polyethylene terephthalate, an adhesive plastic, a heat sealable plastic, a primer or a lacquer.

Normally the adhesion between the layers included in a laminate is not affected after the manufacturing of a container, but the properties of the laminate are deteriorated during a subsequent treatment of the packaging laminate, which impairs its rigidity properties. It has, therefore, surprisingly been found that in contrast to the corresponding packaging laminate manufactured, according to prior art technique, that containers of a laminate manufactured, according to this invention, which are folded in a first step and then endowed with desired mechanical rigidity in a subsequent step, have considerably improved rigidity properties. The improvement of such a container manufactured from such a packaging laminate is thus due to the utilization of the total barrier optimized with reference to the barrier properties.

When converted to dimensionally stable containers the packaging laminate, according to the invention, is subjected to folding. For this purpose, the laminate, as a package material in the form of a sheet or a web, is folded in the same way as package materials which are constructed around a base layer of paper or cardboard to give the container necessary strength and dimensional stability. This folding is accomplished by means of conventional packaging machines intended for such a purpose. Thus, with the base layer being plastic, a folded stackable container can be obtained.

The folding of the base layer, barrier layer, and laminate layer occurs at a stage in which the layers are partially adhered to one another to form a laminate. The layers are partially adhered to a degree at which they can slide at least a small amount with respect to one another.

The partial adhesion between the different layers in the packaging laminate of the invention is chosen in such a way that the packaging laminate can be subjected to the considerable external stress (tensile stress) which takes place during the subsequent folding step in connection with the manufacturing of the container. During folding, some layers in the laminate become stretched and others become compressed along the folding line. This partial adhesion is accomplished in such a way that there is no risk of delamination and/or crack formation, which is usually the case when the adhesion strength already is too high from the beginning without permitting some slip between the laminate layers. This advantageous partial adhesion between the individual layers in the packaging laminate can, according to the invention, be achieved in several different ways, as discussed in detail below. In general, the partial adhesion is accomplished by adjusting the temperature of the laminate when extruded or by applying the liquid layers in some other way in the converting step.

After the packaging laminate has obtained its desired form, by means of folding in a first step, it is then, in a subsequent step, endowed with its desired mechanical rigidity. The adhesion between the layers in the packaging laminate is thus altered during the procedure for manufacturing the completed container. In other words, the layers are fully adhered together during a subsequent heat treatment step to impart dimensional stability and/or mechanical rigidity to the container. In this way a container is achieved which is impermeable to liquid and gas; i.e., possessing good barrier properties.

The partial adherence can, for example, be accomplished by means of heat lamination of the laminate layers in the form of a pre-manufactured film. The adherence can also be accomplished by means of pasting or extrusion. When pasting is used, the paste (dissolved in water or an organic solvent) is applied on one of the layers which then is dried and pressed against the other layer. The laminate layer can also be supplied as film or paste in the form of the above mentioned macromolecule dissolved or dispersed in a solvent, and the solvent or the dispersing agent, respectively, is then evaporated. By the choice of material in the laminate layer and the solvent or dispersing agent, the partial adherence can be adapted in such a way that it becomes sufficient for the further forming of the packaging laminate to a more or less completed container. The adherence by means of pasting is preferably controlled by means of varying the velocity of the laminate web through a drying oven.

A partial adhesion between the two layers in the laminate can also be accomplished by means of extrusion; i.e., one of the layers is extruded while still being melted, if necessary by means of co-extrusion; i.e., the layers are extruded at the same time. The procedure is well known to skilled persons in the art. In this respect, the adhesion is also controlled by means of the velocity of the laminate web.

After the processing of the packaging laminate to the desired shape it is endowed with its desired mechanical rigidity in a subsequent step, by means of exposure to heat and/or pressure. This subsequent heat treatment step results in the layers becoming fully adhered to one another. The heat treatment of the container/laminate can be performed without the application of mechanical pressure thereto. The heat treatment can be accomplished by means of moist or a dry heat. When the adherence is performed by means of pasting dry heat is preferred, and when the adherence is performed by means of extrusion a moist heat is preferred, preferably by autoclaving.

It is an advantage to form and fold a container with the desired impermeability properties for the product in question, while the adherence to the laminate with a disposition to crack is low, (i.e. when this adherence is such that the layers are capable of sliding with respect to one another) since the risk of crack formation in the packaging laminate, principally in its barrier layer, increases with increased adhesion to the laminate layer. During the subsequent step, the container is locked in its final form.

When an extrusion by prior art techniques are used, the procedure is adapted in such a way that the laminate layer does not reach a certain temperature, which depends on the extruded component in the layer in question. This can be accomplished by means of changing the extrusion velocity and/or the extrusion temperature. The laminate layer is thus applied as a hot melted paste which rapidly binds when the layers are cold.

When, for example, an adhesion plastic in the form of modified polypropylene as a laminate layer is extruded on a barrier layer of aluminum foil, the extrusion is adapted in such a way that the plastic melts, to be the only adherence being achieved. The fastening is then completed by means of raising the temperature for a varying period. At the same time, a pressure can be applied on the package material, but this is not always necessary. In this connection an autoclave is preferably used, but an oven can also be used.

The mechanical rigidity of the container can also be achieved in the subsequent step by an initiator integrated in one or several of the layers in the packaging laminate, preferably the base layer, the initiator being brought to initiate that chemical chain reaction which hardens the layers. Such a hardening reaction can thus be achieved by a radical initiator being present in one or several of the laminate layers. Usually, such initiators can be used without an activator or in the presence of a reduction agent. The hardening can be performed at any temperature within the interval of 0° C. to 100° C. However, the interval 40° C. to 90° C. is adequate and preferred.

The use of the packaging laminate, according to the invention, gives extraordinary advantages. The laminate can, by means of folding, be used for the manufacturing of dimensionally stable impermeable packaging containers, which are very suitable for use at highly extreme conditions in a humid environment, including heat treatment with moist heat at a pressure above the atmospheric. Such harsh environments comprise autoclaving at temperatures and periods customary for foodstuff. This means that the laminate is also extremely suitable to be used for the manufacturing of a container which is intended to be filled with a product under aseptic conditions. In this connection the product is sterilized and filled under almost sterile conditions in a likewise sterilized container, which after filling, is sealed in such a way that the filled product, before it is consumed, is not reinfected by micro-organisms during storage.

When such a packaging procedure, a so called “hotfill” is used, the filling material is thus packed, according to prior art technology, while still being hot and in a sterilized, preferably heat sterilized containers. Such a treatment results in that the container is exposed to moist heat, at a temperature of 85° C. or more.

During a subsequent cooling phase, containers exposed to the above mentioned example of heat treatment will also be subjected to environments in which good sealing properties of the container are required against moisture and liquid. During the cooling phase, the filling material is allowed to cool in the container manufactured from a laminate. This cooling can, for example, take place in a fluid bath and also by means of spraying with cool water, if necessary with an accompanying cooling with CO₂ or N₂ in order to rapidly be able to achieve a sufficiently low temperature such as 4° C.

The invention has been described In such full, clear, concise and exact terms as to enable any person skilled in the art to which it pertains to make and use the same. It should be understood that variations, modifications, equivalents and substitutions for components of the specifically described embodiments of the invention may be made by those skilled in the art without departing form the spirit and scope of the invention as set forth in the appended claims. Persons who possess such skill will also recognize that the foregoing description is merely illustrative and not intended to limit any of the ensuing claims to any particular narrow interpretation.

We claim:

1. A method for manufacturing a dimensionally stable and impermeable packaging container from a laminate comprising the steps of:
(a) providing at least one thermoformable base layer devoid of liquid or moisture soaking properties, said base layer comprising a material selected from the group consisting of polypropylene, foamed polypropylene, filled polypropylene, polyethylene terephthalate, filled polyethylene terephthalate, amorphous polyethylene terephthalate and filled amorphous polyethylene terephthalate;
(b) providing a barrier layer, said barrier layer comprising a material selected from the group consisting of aluminum, an aluminum oxide coating, a silica coating, ethylene/vinyl alcohol, polyvinyl alcohol, metalized oriented polyethylene terephthalate and metalized oriented polypropylene;
(c) providing a laminate layer adjacent to said barrier layer and directed towards an inside of said container, said laminate layer comprising a material selected from the group consisting of polypropylene, high density polyethylene, linear low density polyethylene, polyethylene terephthalate, amorphous polyethylene terephthalate, an adhesive plastic, a heat sealable plastic, a primer and a lacquer;
(d) partially adhering said base layer, barrier layer, and laminate layer to form a laminate;
(e) folding said laminate to form a container having a predetermined shape;
(f) heat treating said container with the use of an autoclave for applying moist heat at a pressure greater than atmospheric pressure so as to increase the adhesion of at least one of said base layer, barrier layer, and laminate layers together and impart mechanical rigidity to said container.

2. A method as recited in claim 1 further including the step of cooling said container in a liquid bath.

3. A method as recited in claim 1 wherein said base layer, barrier layer, and laminate layer are partially adhered such that they are held together a sufficient amount to form the laminate but are capable of sliding with respect to one another.

4. A method as recited in claim 1 wherein said step of heat treating said container occurs without the application of mechanical pressure thereto.

5. A method as recited in claim 1 wherein said step of heat treating said container fully adheres said layers together to impart mechanical rigidity to the container.

6. A laminate for manufacturing a dimensionally stable and impermeable packaging container comprising:
(a) at least one thermoformable base layer devoid of liquid or moisture soaking properties, said base layer comprising a material selected from the group consisting of polypropylene, foamed polypropylene, filled polypropylene, polyethylene terephthalate, filled polyethylene terephthalate, amorphous polyethylene terephthalate and filled amorphous polyethylene terephthalate;
(b) a barrier layer partially adhered to said at least one thermoformable base layer, said barrier layer comprising a material selected from the group consisting of aluminum, an aluminum oxide coating, a silica coating, ethylene/vinyl alcohol, polyvinyl alcohol, metalized oriented polyethylene terephthalate and metalized oriented polypropylene; and
(c) a laminate layer positioned adjacent to and partially adhered to said barrier layer, said laminate layer being directed towards an inside of said container, said laminate layer comprising a material selected from the group consisting of polypropylene, high density polyethylene, linear low density polyethylene, polyethylene terephthalate, amorphous polyethylene terephthalate, an adhesive plastic, a heat sealable plastic, a primer and a lacquer and whereby said laminate is heat treated in an autoclave which applies moist heat at a pressure greater than atmospheric pressure so as to increase the adhesion of at least one of said base layer, barrier layer, and laminate layers together to form said laminate.

7. A laminate as recited in claim 6 wherein said barrier layer is partially adhered to said at least one thermoformable base layer, such that they are capable of sliding with respect to one another.

8. A laminate as recited in claim 6 wherein heat treatment of said container occurs without the application of mechanical pressure thereto.

9. A laminate as recited in claim 6 wherein heat treatment of said laminate fully adheres said layers together.
